(19) United States
(12) Patent Application Publication
(10) Pub. No.: US 2014/0037927 A1
(43) Pub. Date: Feb. 6, 2014

(54) MOTOR VEHICLE STRUCTURAL COMPONENT AND ASSOCIATED METHOD OF MANUFACTURE

(71) Applicants: Steve Jeunesse, Mouzou (FR); Jacques Decorme, Montcy Notre Dame (FR); Arnaud Duval, Charleville-Mezieres (FR)

(72) Inventors: Steve Jeunesse, Mouzou (FR); Jacques Decorme, Montcy Notre Dame (FR); Arnaud Duval, Charleville-Mezieres (FR)

(73) Assignee: FAURECIA AUTOMOTIVE INDUSTRIE, NANTERRE (FR)

(21) Appl. No.: 13/983,542

(22) PCT Filed: Jan. 31, 2012
(86) PCT No.: PCT/EP2012/051599

§ 371 Date: Oct. 15, 2013

(30) Foreign Application Priority Data
Feb. 4, 2011 (FR) 1150910

(51) Int. Cl. B60N 2/64; B60N 3/00; B62D 29/04

(52) U.S. Cl. CPC B60N 2/64; B62D 29/043; B60N 3/002
USPC 428/218; 29/897.2; 442/323

(57) ABSTRACT

This component comprises a first mat of felt and a second mat of felt, each felt mat comprising fibers and a resin binding the fibers. It comprises a spacer interposed between the first mat and the second mat, the first mat and the second mat being fixed to opposite faces of the spacer. At least one of the first mat and the second mat comprises at least 50 wt % of wood fibers bound together by the resin.

### CROSS-REFERENCE TO RELATED APPLICATIONS

This application is the National Stage of International Application No. PCT/EP2012/051599, filed Jan. 31, 2012. The International Application claims priority to French Application No. 11 50910, filed Feb. 4, 2011. The International Application published on Aug. 9, 2012 as WO 2012/104318. All of the above applications are incorporated herein by reference.

### FIELD OF THE INVENTION

The present invention relates to a motor vehicle structural component, of the type comprising a first mat of felt and a second mat of felt, each felt mat comprising fibers and a resin binding the fibers; a spacer interposed between the first mat and the second mat, the first mat and the second mat being fixed to opposite faces of the spacer.

### BACKGROUND

Such a component is designed in particular to form a motor vehicle floor, such as a passenger compartment or a floor and false bottom of a trunk, a door panel, a rear tray table, a seatback in row 2 or 3, or a wall delimiting a storage space.

Known from U.S. Pat. No. 6,761,953 are motor vehicle components of the aforementioned type made from glass fiber webs assembled on a honeycomb spacer.

Such components are relatively rigid and must have good mechanical properties, in particular in flexure.

However, the components of the aforementioned type are not fully satisfactory. In fact, the presence of polyurethane resins inevitably increases the cost of the component. Furthermore, these components are not made with a base of natural materials.

One aim of the invention is therefore to obtain a motor vehicle structural component having good mechanical properties while remaining lightweight, the component being inexpensive and respectful of the environment.

### SUMMARY

To that end, the invention relates to a component of the aforementioned type, characterized in that at least one of the first mat and the second mat includes at least 50 wt % of wood fibers bound together by the resin.

The component according to the invention may comprise one or more of the following features, considered alone or according to any technically possible combination(s):
the length of the wood fibers is smaller than 20 mm, and is advantageously between 5 mm and 15 mm, in particular between 7 mm and 12 mm;
each felt mat has a density between 0.8 and 1.2, advantageously between 0.9 and 1.1;
at least one of the first felt mat and the second felt mat includes a non-zero quantity and less than 45 wt % of synthetic fibers, advantageously polyester fibers and/or bicomponent polyester fiber;
at least one of the first felt mat and the second felt mat includes between 60 wt % and 80 wt % wood fibers, between 10 wt % and 30 wt % synthetic fibers, and between 5 wt % and 25 wt % resin;
at least one of the first felt mat and the second felt mat includes between 65 wt % and 75 wt % wood fibers, between 15 wt % and 25 wt % synthetic fibers, and between 5 wt % and 15 wt % resin;
at least one of the first felt mat and the second felt mat includes a non-zero quantity of natural fibers distinct from the wood fibers, the quantity by weight of natural fibers being less than 45 wt %;
at least one of the first felt mat and the second felt mat includes a non-zero quantity of natural fibers distinct from wood fibers, the length of the natural fibers advantageously being greater than 20 mm, and in particular between 20 mm and 150 mm, advantageously between 30 mm and 100 mm, advantageously between 60 mm and 80 mm;
at least one of the first felt mat and the second felt mat is made from wood fibers;

the resin is a thermosetting resin such as an acrylic resin, a phenolic resin, a polyurethane resin, an epoxy resin or a methacrylate resin;
the wt % of resin in each of the first felt mat and the second felt mat is less than 25 wt %, and advantageously between 8 wt % and 20 wt %;
at least one of the first felt mat and the second felt mat is fastened on the spacer by a binder;
the thickness of the spacer is between 2 mm and 100 mm, and is in particular between 5 mm and 20 mm;
the surface density of the spacer is lower than the surface density of each of the first felt mat and the second felt mat, and is advantageously between 50 g/m² and 1,000 g/m², in particular between 400 g/m² and 800 g/m²;
the spacer is made up of a cellular body, advantageously a honeycomb body;
the spacer is made from paper or cardboard;
it is thermoset;
it forms a motor vehicle floor, such as a passenger compartment floor or a floor and false bottom of the trunk, a rear tray table, a door panel, a seatback in rows 2 and 3, or a wall delimiting a storage area;
the component is non-planar and has raised portions.

The invention also relates to a method for manufacturing a motor vehicle structural component, of the type having the following steps of hot mold forming of a first felt mat and a second felt mat, simultaneously or separately, each felt mat comprising fibers and a resin binding the fibers, at least one of the first felt mat and the second felt mat including at least 50 wt % of wood fibers bound together by the resin; positioning a spacer between the first felt mat and the second felt mat; fastening the first felt mat and the second felt mat on opposite faces of the spacer.

The method according to the invention may include the following feature of
the forming step and the fastening step are carried out in the same hot mold, the method advantageously including arranging the central core in the mold between the felt mats during the forming step of each felt mat, and removing the central core from the mold to allow the insertion of the spacer between the first felt mat and the second felt mat during the fastening step.

### BRIEF DESCRIPTION OF THE FIGURES

The invention will be better understood upon reading the following description, provided solely as an example, and done in reference to the appended drawings, in which:

FIG. 1 is a cross-sectional view of a first structural equipment component according to the invention;

FIG. 2 is a partial cross-sectional view of an alternative of the component according to the invention;

FIG. 3 is a partial cross-sectional view of another alternative component according to the invention;

FIGS. 4 to 7 show the different steps of manufacturing a component according to the inventive method.

### DETAILED DESCRIPTION

Hereafter, the terms “inner” and “outer” are generally understood in reference to the component shown in the figures.

Furthermore, the percentages are percentages by weight, unless otherwise indicated.

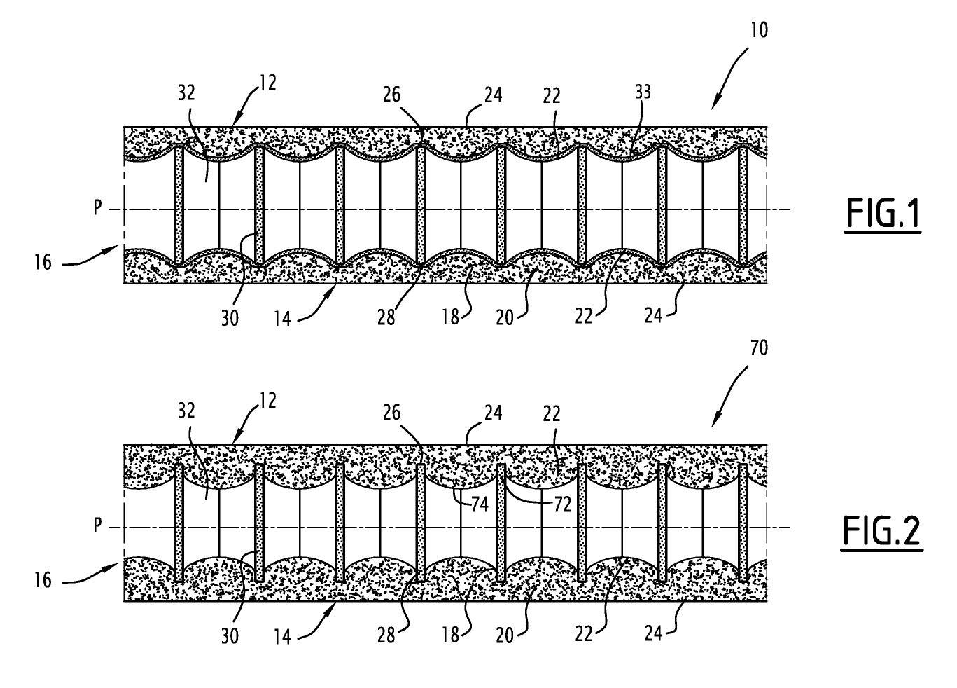

A first motor vehicle equipment component 10 according to the invention is shown in FIG. 1. This component is designed in particular to form a motor vehicle floor, such as a passenger compartment floor or a floor and false bottom of a trunk, a door panel, a rear tray table, a seatback for rows 2 and 3, or a wall delimiting a storage space.

As illustrated by FIG. 1, the component 10 includes a first felt mat 12, a second felt mat 14 and a spacer 16 positioned between the mats 12, 14, each of the mats 12, 14 being fastened on the spacer 16.

Each mat 12, 14 includes fibers 18 and a resin 20 binding the fibers 18 together.

According to the invention, each mat 12, 14 includes at least 50% wood fibers, in particular short wood fibers, compared to the total weight of the mat 12, 14.

“Wood fibers” are cellulose fibers in particular obtained by cutting trees comprising a trunk, such as pines.

As is well known, wood is an organic material in particular made up of cellulose fibers coated in a lignin matrix. The wood is located in the trunk of the trees.

The wood fibers are advantageously obtained by offcut resulting from the separation between the core of the tree on the one hand, and the rest of the trunk and the bark on the other hand. The wood fibers are obtained by etching the offcut.

The wood fibers thus obtained are assembled together to form a ply.

As seen above, the weight proportion of wood fibers in each mat 12, 14 is greater than 50 wt %, and is in particular between 60 wt % and 90 wt %, for example between 60 wt % and 75 wt %, or between 80 wt % and 90 wt %, with respect to the total weight of the mat 12, 14.

The length of the wood fibers is strictly shorter than 20 mm, in particular shorter than 10 mm. This length is advantageously between 5 mm and 15 mm, in particular between 7 mm and 12 mm.

In an example, at least one of the first mat 12 and the second mat 14 further includes synthetic fibers, for example polyester fibers, bicomponent polyester-based fibers, etc.

The quantity of synthetic fibers is then non-zero, and is in particular between 0 wt % and 45 wt %, for example between 10 wt % and 30 wt %.

In one alternative, the synthetic fibers include a mixture of mono-component polyester fibers and polyester-based bicomponent fibers. The bicomponent polyester-based fibers include two types of polyester having different melting points, while the mono-component polyester fibers are made up of a single type of polyester with a single melting point.

The weight ratio of mono-component polyester fibers in the mixture of synthetic fibers is greater than 50 wt %, and in particular between 60 wt % and 90 wt %, for example equal to 70 wt % or 80 wt %, with respect to the total weight of the mixture of synthetic fibers.

The synthetic fibers in particular improve the formability of the component 10. This makes it possible for example to produce non-planar components having raised portions, such as automobile trunk floors, passenger compartment doors, door panels, tray tables for row 2 or 3 seatbacks.

The resin 20 assembles the fibers 18 to each other. It impregnates the web of fibers 18 to mechanically bind the fibers 18 together.

The weight percentage of resin 20 contained in each mat 12, 14 is less than 25 wt % and is advantageously between 5 wt % and 25 wt %. It is in particular between 8 wt % and 20 wt %.

The resin 20 used is advantageously a thermosetting resin that sets irreversibly, in particular by chemical cross-linking, under the effect of heat or radiation. Such resins generally assume the form of a powder or granulates before being cross-linked, and have a solid form once cross-linked.

Examples of thermosetting resin are for example acrylic resin, methacrylate resin, phenolic resin, polyurethane resin, or epoxy resin.

The felt mats 12, 14 thus obtained are compressed in a hot mold to have a density between 0.8 and 1.2, advantageously between 0.9 and 1.1.

The felt mats 12, 14 are rigid. Their flexural strength depends on the densification of the felt mats, the density of the felt mats and the weight of the resin.

The mean density of each mat 12 and 14 is for example between 50 g/m² and 2,000 g/m², advantageously between 600 g/m² and 1,600 g/m².

The mean thickness of each mat 12, 14 is smaller than the thickness of the spacer 16, considered perpendicular to a baseline surface of the component 10, between an inner surface 22 and an outer surface 24 of the mat 12, 14.

The mean thickness of each mat 12, 14 before compression is, for example, between 5 mm and 20 mm, advantageously between 5 mm and 7 mm.

The mean thickness of each mat 12, 14 after compression depends on the density of the felt and the targeted density between 0.8 and 1.2.

The spacer 16 is interposed between the mats 12, 14. Its density is between 10 g/dm³ and 500 g/dm³, and more particularly between 20 g/dm³ and 50 g/dm³.

Advantageously, the spacer 16 is made with a base of a cellular or honeycomb structure.

Thus, the spacer 16 has a plurality of walls 30 substantially perpendicular to a mean plane of the component 10, the walls 30 delimiting central spaces 32 with a closed contour forming the cells. Thus, each central space or cell 32 emerges across from the respective inner face 26 of a mat 12, 14.

In an example, the cells 32 define polygonal meshes, in particular hexagonal.

The maximum transverse dimension of the hexagonal meshes, considered parallel to a mean plane P of the component, is greater than 5 mm, and is for example between 5 mm and 20 mm, in particular between 8 and 10 mm.

Alternatively, the mesh is undulated. In that case, the amplitude of the undulations is between 5 and 15 mm, and the pitch (distance between two undulation peaks) is between 5 and 20 mm, advantageously 8 mm and 16 mm.

The spacer 16 is advantageously made from a light material, such as paper or cardboard.

The density of the spacer 16 is low. This density is in particular less than 2,000 g/m², and is advantageously between 50 g/m² and 1,200 g/m².

Preferably, this density is less than 1,000 g/m² and is substantially between 400 g/m² and 800 g/m²

The density of the spacer 16 is thus lower than the density of each mat 12, 14, and is advantageously 1.5 to 2.5 times lower than the density of each mat 12, 14.

Thus, the component 10 has a suitable degree of lightness, due to the low density of the spacer 16.

The spacer 16 advantageously has a thickness greater than 2 mm, and for example between 2 mm and 100 mm, in particular between 5 mm and 20 mm, advantageously substantially equal to 15 mm, considered between its opposite faces 26, 28.

The edge of the walls 30 delimits the opposite faces 26, 28 of the spacer 16 on which the first mat 12 in the second mat 14 are respectively assembled.

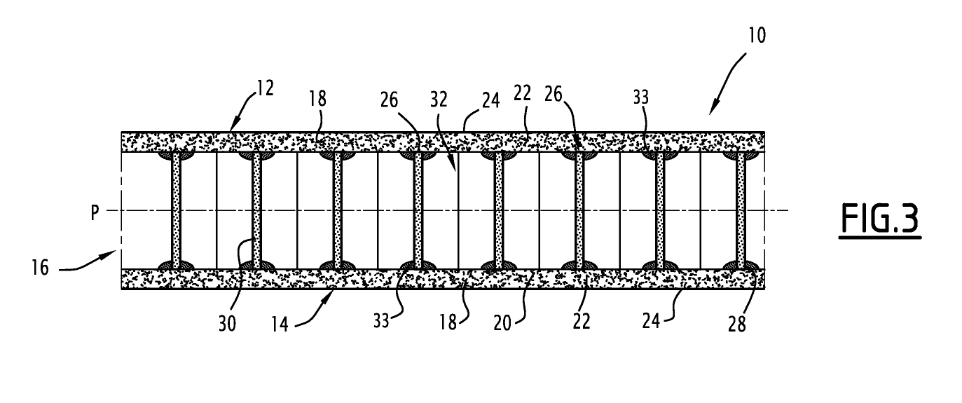

In the component 10 shown in FIG. 1 and FIG. 3, a binder 33 is used to fasten the first mat 12 on the first base 26 and the second mat 14 on the second base 28. This binder is for example a glue, a film or another adhesive material compatible with the composition of the mats 12, 14 and the spacer 16.

In the particular example of FIG. 1, the binder 33 is a film substantially covering the inner surface 22 of the mat 12, 14.

This binder may be part of the epoxy, acrylic, methacrylate, polyurethane or polyvinyl acetate families.

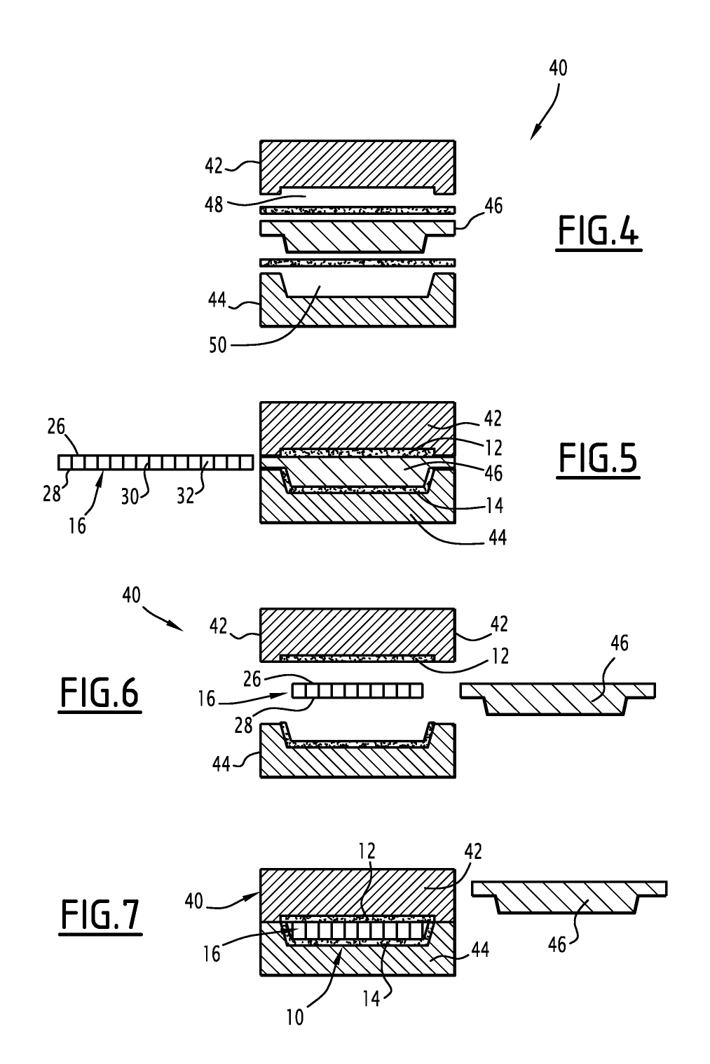

A manufacturing method according to the invention, for producing the component 10, is illustrated by FIGS. 4 to 7.

This method is carried out in a mold 40 including a first hollow half-mold 42, a second hollow half-mold 44, and a core 46 inserted removably between the first hollow half-mold 42 and the second hollow half-mold 44.

The first half-mold 42 is movable with respect to the second half-mold 44 between an open position of the mold, shown in FIG. 4 or FIG. 6, an intermediate closed position in the presence of the core 46, shown in FIG. 5, and a completely closed position of the mold 40, shown in FIG. 7, in the absence of the core 46.

The manufacturing method for the component 10 initially includes a step for inserting fiber webs designed to form the mats 12 and 14 in the intermediate spaces 48, 50 respectively defined between the first half-mold 42 and the core 46 and between the second half-mold 44 and the core 46. The fiber webs are impregnated with resin 20 in solid form.

Preferably, the fiber webs are inserted into the mold 40 without prior heating, at the temperature prevailing outside the mold 40 or at least at a temperature lower than that necessary to melt the resin 20.

The first half-mold 42, the second half-mold 44 and the core 46 are heated to a temperature higher than that necessary to cure the resin.

The temperature of the half-molds and the core is for example greater than 200° C., and is in particular between 210° C. and 250° C., advantageously between 230° C. and 240° C.

Then, the mold 40 is placed in its intermediate position, as shown in FIG. 5. The fiber webs are compressed and cut simultaneously by cutting means (not shown) to have a density between 0.8 and 1.2, for example between 0.9 and 1.1. The resin 20 is then thermoset and the felt mats 12, 14 are formed to the dimensions of the component 10.

Then, as shown in FIG. 6, the mold 40 is brought to its open position. The core 46 is next removed outside the space situated between the half-molds 42, 44. The spacer 16, previously equipped with a binder 33 designed to fasten the mats 12, 14 on its opposite faces 26, 28, is inserted between the two half-molds 42, 44.

The mold 40 is then brought into its completely closed position, shown in FIG. 7. The half-molds 42 and 44 are heated. During closing of the mold, each mat 12, 14 is firmly pressed on one face 26, 28 of the spacer 16. The binder 33 is then thermally and/or pressure activated to permanently fasten each mat 12, 14 on the spacer 16.

Simultaneously, the spacer 16 is cut along the perimeter of the component 10 by cutting means (not shown).

The method according to the invention is therefore particularly easy to implement and inexpensive, since it only requires one mold 40, the component 10 being completely formed in the mold 40.

In this method, the presence of the core 46 makes it possible to ensure effective compression of each of the mats 12, 14 and a minimal insertion of the mats into the central spaces, as illustrated by FIG. 3.

In one alternative method, the two felt mats 12, 14 are made separately and are compressed as previously described. The spacer 16 is then inserted with the binder 33 and the compressed felt mats 12, 14, hot or heated, into a mold. The mold is then closed to assemble the mats 12, 14 on the spacer 16.

In another alternative method, the spacer 16, the opposite faces 26, 28 of which are provided with binder, is inserted between the uncompressed felt webs in a mold. Then, the mold is closed and is heated to cause cross-linking of the resin, compression of the fiber webs, and fastening of the mats 12, 14 thus formed on the spacer 16.

In an alternative component 10, the fibers 18 making up at least one of the first felt mat 12 and the second felt mat 14 are exclusively from wood fibers.

In that case, the weight percentage of wood fibers is greater than 75 wt %, advantageously greater than 80 wt %, the rest of the mat 12, 14 being formed from resin 20 binding the fibers 18. For example, the felt mat 12, 14 includes approximately 85 wt % wood fibers and approximately 15 wt % acrylic or phenolic resin.

In another alternative component 10, at least one of the first mat 12 and the second mat 14 includes natural fibers, in addition to wood fibers. These natural fibers for example partially or completely replace the synthetic fibers described above. The weight percentage of natural fibers is then greater than 10 wt %, and in particular between 10 wt % and 50 wt %, in particular between 15 wt % and 25 wt %.

The natural fibers are then made from a plant which may be flax, hemp, kenaf, bamboo or sisal.

The length of the natural fibers is greater than the average of that of the wood fibers. On average, the length of the natural fibers is thus greater than 20 mm, and in particular between 20 mm and 150 mm, for example between 30 mm and 100 mm, and in particular between 60 mm and 90 mm.

For example, the felt mat 12, 14 includes approximately 65% wood fibers, approximately 20% natural fibers and approximately 15% acrylic or phenolic resin.

In another alternative component 10, at least one of the first mat 12 and the second mat 14 includes glass fibers, in addition to the wood fibers. These glass fibers for example partially or completely replace the synthetic fibers described above.

The second component 70 according to the invention is shown in FIG. 2. Unlike the first component 10, at least one of the first mat 12 and the second mat 14 is fastened on the spacer 16 without binder, by mechanical engagement on the spacer 16.

To that end, at least one region 72 of the wall 30 of the spacer 16 is inserted into the mat 12, 14 and is maintained by the resin 20 making up the mat 12, 14 and/or by mechanical engagement in the fibers. Thus, due to the mechanical engagement of the region 72 in the mat 12, 14 and the presence of resin 20, the mat 12, 14 is fastened on the spacer 16, without it being necessary to add a binder.

At least one region 74 of the mat 12, 14 situated between two opposite walls 30 then protrudes into the central space 32 between the walls 30.

The component 10 illustrated in FIG. 3 differs from the component 10 illustrated in FIG. 1 in that the binder 33 is formed by seams of adhesive material described above, delimiting spaces with no binder on the inner surface 22.

Advantageously, the binder 33 is deposited on the edge of the walls 30 of the spacer and/or near the edge.

The motor vehicle components 10, 70 obtained by using inexpensive wood fibers, combined with a particularly effective manufacturing method, therefore have a reduced cost. This cost optimization occurs without losing mechanical properties, while preserving the possibility of forming components with complex structures, which may be non-planar.

The components 10, 70 thus formed further have a composition that respects the environment, in particular because they use natural materials and the quantity of resin necessary for the mechanical strength of the component 10, 70 is low.

Lastly, the motor vehicle components 10, 70 are thermoset, and they therefore have good mechanical strength irrespective of the ambient temperature, even at high temperatures, for example above 100° C. and in particular around 110° C.

“Thermoset” means that the component is irreversibly set, such that increasing the temperature of the component does not cause creep, softening, or melting of the component, unlike a thermoplastic component. A “thermoset” component according to the invention is also infusible after cross-linking the resin 20.

In still another alternative, the spacer 16 is made from a foam, such as a PU (polyurethane) or PP (polypropylene) or PES (polyester) foam or a foam waste-based foam, or material such as expanded polystyrene or cork or balsa, offering a density lower than that of the first mat 12 and the second mat 14.

It results directly and unambiguously from the preceding that the density of each felt mat 12, 14 obtained after compression is between 0.8 and 1.2, advantageously between 0.9 and 1.2, and in particular between 0.9 and 1.1.

These densities are particularly high compared to those of a material made from traditional wood, such as high-density fiberboards (HDF).

To form mats 12, 14 with such a density, it is advantageous to use mats with an inner surface area of 10 m², in particular between 1 m² and 5 m².

It is then possible to work with high-power presses to compress the felt mats 12, 14. These presses for example have a minimum pressure greater than 200 tons, in particular between 200 tons and 250 tons. This makes it possible to accommodate materials formed with a base of thermosetting resin as described above.

In the implementation of the method according to the invention, as it is described in FIGS. 4 to 7, the spacer 16 preserves its full integrity. In fact, the high pressure that is used to produce the mats 12, 14 compressed with the aforementioned densities is applied by pressing on a core 46 that is separate from the spacer 16.

The pressure applied may therefore be very high, in the ranges described above, without risk of deterioration of the spacer 16. It is possible next to use a low-density spacer 16, having more limited compression mechanical properties, such as a cardboard, foam, honeycomb, polystyrene bead spacer.

Furthermore, the method according to the invention makes it possible to produce three-dimensional components, which sometimes lead to greatly stretching the mats 14, 16 during forming.

The presence of long fibers, in particular longer than 20 mm, in particular between 20 mm and 150 mm, advantageously between 30 mm and 100 mm, and still more advantageously between 60 mm and 80 mm, prevents the mat 12, 14 from tearing during forming.

These long fibers make up manufacturing additives, as they do not necessarily correspond to mechanical strengthening of the mats 12, 14.

More generally, the density of resin 20 contained in each mat 12, 14 may be greater than 25 wt %. This percentage is generally less than 40 wt %, and may be between 26 wt % and 40 wt %.

As specified above, the method according to the invention is particularly well-suited for producing non-planar parts having raised portions.

1. A motor vehicle structural component, of the type comprising:
a first mat of felt and a second mat of felt, each felt mat comprising fibers and a resin, binding the fibers;
a spacer interposed between the first felt mat and the second felt mat, the first felt mat and the second felt mat being fixed to opposite faces of the spacer;
wherein at least one of the first mat and the second mat comprises at least 50 wt % of wood fibers bound together by the resin.

2. The component according to claim 1, wherein the length of the wood fibers is smaller than 20 mm.

3. The component according to claim 1, wherein each felt has a density comprised between 0.8 and 1.2.

4. The component according to claim 1, wherein at least one of the first felt mat and the second felt mat includes a non-zero quantity and less than 45 wt % of synthetic fibers.

5. The component according to claim 4, wherein at least one of the first felt mat and the second felt mat includes between 60 wt % and 80 wt % wood fibers, between 10 wt % and 30 wt % synthetic fibers, and between 5 wt % and 25 wt % resin.

6. The component according to claim 1, wherein at least one of the first felt mat and the second felt mat comprises a non-zero quantity and less than 45 wt % of natural fibers distinct from wood fibers.

7. The component according to claim 1, wherein at least one of the first felt mat and the second felt mat comprises a non-zero quantity of natural fibers distinct from wood fibers, the length of the natural fibers advantageously being greater than 20 mm, the long fibers advantageously being natural fibers distinct from wood fibers.

8. The component according to any one of claims 1 to 3, wherein all of the fibers of at least one of the first felt mat and the second felt mat are wood fibers.

9. The component according to claim 1, wherein the resin is at least one of a thermosetting resin such as an acrylic resin, a phenolic resin, a polyurethane resin, an epoxy resin or a methacrylate resin.

10. The component according to claim 9, wherein the weight percentage of resin in each of the first felt mat and the second felt mat is less than 40 wt %.

11. The component according to claim 1, wherein at least one of the first felt mat and the second felt mat is fastened on the spacer by a binder.

12. The component according to claim 1, wherein the thickness of the spacer is comprised between 2 mm and 100 mm.

13. The component according to claim 1, wherein the surface density of the spacer is lower than the surface density of each of the first felt mat and the second felt mat, and is advantageously comprised between 50 g/m² and 1,000 g/m².

14. The component according to claim 1, wherein the spacer is made up of a cellular body, advantageously a honeycomb body.

15. The component according to claim 14, wherein the spacer is made from paper or cardboard.

16. The component according to claim 1, wherein it is thermoset.

17. The component according to claim 1, wherein it forms a motor vehicle floor, such as a passenger compartment floor or a floor and false bottom of the trunk, a rear tray table, a door panel, a seatback in rows 2 and 3, or a wall delimiting a storage area.

18. A method for manufacturing a motor vehicle structural component, of the type comprising the following steps:
hot mold forming of a first felt mat and a second felt mat, simultaneously or separately, each felt mat comprising fibers and a resin binding the fibers, at least one of the first felt mat and the second felt mat including at least 50 wt % of wood fibers bound together by the resin;
positioning a spacer between the first felt mat and the second felt mat;
fastening the first felt mat and the second felt mat on opposite faces of the spacer.

19. The method according to claim 18, wherein the forming step and the fastening step are carried out in the same hot mold, the method advantageously comprising arranging the central core in the mold between the felt mats during the forming step of each felt mat, and removing the central core form the mold to allow the insertion of the spacer between the first felt mat and the second felt mat during the fastening step.
